(19) United States
(12) Patent Application Publication
(10) Pub. No.: US 2008/0220251 A1
(43) Pub. Date: Sep. 11, 2008

(54) Ultra Violet-Cured Pressure-Sensitive Adhesive Tape or Film Without Supporting Substrate

(76) Inventor: Shunsuke Takaki, Kanagawa Pref (JP)

Correspondence Address: 3M INNOVATIVE PROPERTIES COMPANY, PO BOX 33427, ST. PAUL, MN, 55133-3427, US

(21) Appl. No.: 11/911,676

(22) PCT Filed: Apr. 18, 2006
(86) PCT No.: PCT/US06/14565

§ 371 Date: Apr. 28, 2008

(30) Foreign Application Priority Data
Apr. 18, 2005 (JP) 2005-120204

(51) Int. Cl. B32B 7/10; B05D 3/06; C08G 73/10

(52) U.S. Cl. 428/345; 427/595; 528/367

(57) ABSTRACT

A pressure-sensitive adhesive tape or film obtained by curing a UV-curable pressure-sensitive adhesive composition containing a UV-curable polymer or oligomer, wherein the UV curing is controlled to give a higher degree of cure to one surface of the pressure-sensitive adhesive tape or film than that on the opposite surface and thereby the pressure-sensitive adhesive property is suppressed on the one surface and maintained on the opposite surface.

### TECHNICAL FIELD

The present invention relates to a pressure-sensitive adhesive tape or film being ultraviolet radiation-cured by controlling the degree of cure in the thickness direction of the pressure-sensitive adhesive tape or film without requiring a supporting substrate.

### BACKGROUND ART

In general, the pressure-sensitive adhesive tape or film is constructed by coating a pressure-sensitive adhesive on one surface or both surfaces of a supporting substrate, and the supporting substrate carries the pressure-sensitive adhesive during use. On the other hand, a self-supporting pressure-sensitive adhesive tape (e.g., without the supporting substrate when used) is also known.

For example, (Japanese Unexamined Patent Publication (Kokai) No. 58-145490 discloses a thin transfer film without a supporting substrate. More specifically, this transfer film comprises a pressure-sensitive adhesive layer, an ink-receiving layer consisting of fine particulates provided on one surface of the pressure-sensitive adhesive layer, and a printed ink layer provided on the ink-receiving layer, and is used for the purpose of decoration.

Japanese Unexamined Patent Publication (Kokai) No. 2000-109763 discloses a processed pressure-sensitive adhesive tape having a release paper. More specifically, this processed pressure-sensitive adhesive tape comprises a pressure-sensitive adhesive layer and a partial pressure-sensitive adhesion blocking layer comprising a non-pressure-sensitive adhesive printing ink provided on the smooth surface of the release paper. The partial pressure-sensitive adhesion blocking layer is transferred and provided on the pressure-sensitive adhesive layer.

The pressure-sensitive adhesive tapes with no supporting substrate, the adhesive force is suppressed by coating a fine particle or ink on one surface of the pressure-sensitive adhesive layer. Such a technique is disadvantageous in view of production of the pressure-sensitive adhesive tape, because a material different from the pressure-sensitive adhesive layer must be separately prepared and coated on the pressure-sensitive adhesive layer. Also, the structure having multiple layers including a pressure-sensitive adhesive layer and a surface coat layer has a problem that elongation of the pressure-sensitive adhesive layer causes defects such as cracking in the surface coat layer, and exposing the adhesive layer.

### BRIEF DESCRIPTION OF THE DRAWINGS

FIG. 1A cross-sectional view of a precut product of the pressure-sensitive adhesive tape or film of the present invention.

FIG. 2 A cross-sectional view of a precut product of the pressure-sensitive adhesive tape or film of the present invention.

FIG. 3 A cross-sectional view of the pressure-sensitive adhesive tape or film when a roll-type product is unrolled.

FIG. 4 A cross-sectional view of the pressure-sensitive adhesive tape or film when a roll-type product is unrolled.

### SUMMARY OF THE INVENTION

An object of the present invention is to provide a pressure-sensitive adhesive tape or film that does not require a supporting substrate.

In one embodiment, the present invention provides a pressure-sensitive adhesive tape or film obtained by curing a UV-curable pressure-sensitive adhesive composition containing a UV-curable polymer or oligomer, wherein the UV curing is controlled to give a higher degree of cure to one surface of the pressure-sensitive adhesive tape or film than that on the opposite surface. Thereby the pressure-sensitive adhesive property is suppressed on the one surface and is maintained on the opposite surface.

In another embodiment, the present invention provides a UV-curable pressure-sensitive adhesive composition containing a UV-curable polymer or oligomer, which is used for the production of the above-described pressure-sensitive adhesive tape or film, the UV-curable pressure-sensitive adhesive composition comprising a UV-curable polymer or oligomer and adjusted to exhibit an absorbance of 1 to 4 at the UV wavelength for the coating thickness on performing the UV curing.

### EFFECTS OF THE INVENTION

According to the present invention, when ultraviolet light (hereinafter referred to as “UV”) having a specific wavelength and a specific intensity is irradiated along the thickness direction from one side of a surface of a coating formed of an ultraviolet-curable pressure-sensitive adhesive composition having absorptivity to ultraviolet light at that specific wavelength, then the tack or adhesive force is substantially suppressed on the one side of that surface and the tack or adhesive force is maintained on the opposite side of that surface, whereby a pressure-sensitive adhesive tape or film without a supporting substrate can be obtained.

The pressure-sensitive adhesive tape or film of the present invention (hereinafter referred to as “a self-supporting pressure-sensitive adhesive tape”, “a pressure-sensitive adhesive tape” or the like) is obtained by curing a curable composition containing a UV-curable polymer or oligomer and having absorptivity to ultraviolet light at a specific wavelength, under specific conditions. This curable composition preferably has ultraviolet absorptivity to an extent of exhibiting an absorbance of 1 to 4 for a certain coating thickness on performing the UV curing by using a certain ultraviolet wavelength. With such an absorbance level, when the UV curing is performed at a certain ultraviolet wavelength, the coated composition can be fully cured on the surface irradiated with ultraviolet light, and as a result, the pressure-sensitive adhesive property (for example, tack and adhesive force) is substantially suppressed. On the other hand, the ultraviolet light is absorbed by the coated composition as it proceeds in the coating thickness direction of the composition, and as a result, curing by ultraviolet light occurs less on the opposite side of the surface and the pressure-sensitive adhesive property is maintained. In this way, a pressure-sensitive adhesive tape without a supporting substrate, which has a non-pressure-sensitive adhesive property on one side of a single-layer pressure-sensitive adhesive layer and has a pressure-sensitive adhesive property on the opposite side, can be obtained.

The UV-curable pressure-sensitive adhesive composition is a curable mixture containing a UV-curable polymer or oligomer and has ultraviolet absorptivity. In one embodiment, the UV-curable pressure-sensitive adhesive composition comprises an ultraviolet absorbent and a UV-curable polymer or oligomer. In another embodiment, the UV-curable pressure-sensitive adhesive composition comprises a UV-curable polymer or oligomer which itself has ultraviolet absorptivity.

The UV-curable polymer or oligomer is, for example, a polymer or oligomer having a (meth)acrylate group within the molecule, in which the (meth)acrylate group undergoes a reaction upon irradiation of ultraviolet light to cause crosslinking and thereby effect the curing. The polymer or oligomer having a (meth)acrylate group within the molecule has the (meth)acrylate group, for example, at the terminal of the polymer or oligomer chain.

The terms “(meth)acrylate” and “(meth)acrylic acid” mean an acrylate or methacrylate and an acrylic acid or methacrylic acid, respectively. Also, the UV-curable polyurethane polymer or oligomer having a (meth)acrylate group is called “a UV-curable acrylate polymer or oligomer”.

More specifically, the UV-curable polymer or oligomer in one embodiment is a UV-curable polyurethane acrylate polymer or oligomer having a (meth)acrylate group, preferably a UV-curable polyurethane acrylate polymer or oligomer having a (meth)acrylate group at its terminal. Such a UV-curable polymer or oligomer is, for example, a polymer or oligomer obtained from a reaction mixture containing a polyol, a polyisocyanate, a hydroxyl group-containing acrylate monomer and/or a hydroxyl group-containing methacrylate monomer.

In general, the polyester polyol tends to render the produced oligomer hydrophobic, and the polyether polyol tends to render the produced oligomer hydrophilic. For example, the polyol can be (1) a polypropylene glycol, (2) a polyalkylene glycol based on a random or block copolymer comprising from 10 to 40% of ethylene oxide and from 60 to 90% of propylene oxide, or (3) a polyester polyol. Therefore, the polyester polyol contributes to the adhesive force and waterproofing property of the pressure-sensitive adhesive, whereas an ethylene oxide unit in a polyalkylene glycol imparts hydrophilicity to the pressure-sensitive adhesive. A propylene oxide unit tends to impart adhesive force and waterproofing property to the pressure-sensitive adhesive.

The molecular weight of the polyol correlates with the viscosity of the oligomer. The oligomer having a low molecular weight becomes a flowing liquid at ordinary temperature, whereas the oligomer having a high molecular weight is a high viscosity substance at ordinary temperature and becomes a flowing oligomer under heat. In view of coatability of the pressure-sensitive adhesive composition, the molecular weight of the polyol is preferably on the order of 2,000 to 4,000.

Examples of the hydroxyl group-containing (meth)acrylate monomer include 2-hydroxyethyl(meth)acrylate. The hydroxyl group-containing (meth)acrylate monomer content in the oligomer raw material can the cross-linking and thus affect the physical properties after UV curing. The hydroxyl group-containing (meth)acrylate monomer is preferably present in a proportion of 0.2 to 4 mol % in the oligomer raw material. In particular, when the hydroxyl group-containing (meth)acrylate monomer is present in an amount of 0.5 mol % or more, a nontacky substance, or a substance reduced in the tack, is obtained after sufficient UV curing and this can be effectively used in the present invention.

Examples of the polyisocyanate include general organic diisocyanates such as isophorone diisocyanate.

In the case of using the above-described UV-curable polymer or oligomer, the UV-curable pressure-sensitive adhesive composition usually contains a UV photoinitiator. As for the UV curing agent, a UV initiator employed for the formation of typical acryl-based resins and suited for the energy band of ultraviolet light irradiated can be used in a usual amount. However, when the pressure-sensitive adhesive tape of the present invention is used as a medical pressure-sensitive adhesive tape for application to skin, the initiator must be selected by taking account of irritation to skin, dissolving property and odor after irradiation. Examples of the initiator include, but are not limited to, those selected from the group consisting of benzophenones substituted by an ionic group, a hydrophilic group or both thereof; thioxanthones substituted by an ionic group, a hydrophilic group or both thereof; and phenyl ketones such as 4-substituted-(2-hydroxy-2-propyl)phenyl ketone (wherein the 4-substituted group is an ionic or hydrophilic group). Particularly preferred examples of the UV initiator include IRGACURE-2959 [1-(4-(2-hydroxy)-phenyl)-2-2-hydroxy-2-methyl-1-propan-1-one)] produced by Ciba Specialty Chemicals. As for the amount added, suitable formulation is determined from the relationship with the UV dose and adhesive properties, but when the blending balance of the pressure-sensitive adhesive is considered, the amount of the UV initiator blended is generally from 0.01 to 10 wt % based on the weight of the pressure-sensitive adhesive composition.

Examples of the commercially available UV-curable polyurethane acrylate oligomer include, but are not limited to, NK-OLIGO series of Shin-Nakamura Chemical Co., Ltd., Ebecry series of Daicel UCB, and Light-Tack PUA series of Kyoeisha Chemical Co., Ltd. in Japan. Such an oligomer becomes weakly adhesive with no tack when fully cured by adding a UV photoinitiator, and insufficiently adheres to human skin. The pressure-sensitive adhesive is further required to have flexibility to conform to the human skin surface. In order to obtain this property, the glass transition point (Tg) of the polymer constituting the pressure-sensitive adhesive may be lower than the temperature during use. Accordingly, an oligomer having a glass transition point (Tg) of 0° C. or less is preferred as the UV-curable oligomer.

The UV-curable pressure-sensitive adhesive composition should be adjusted to a specific absorbancy so as to control the degree of cure in the thickness direction from the top surface to the bottom surface (from one side to the opposite side). For this purpose, an ultraviolet absorbent is added to the UV-curable pressure-sensitive adhesive composition when necessary, for example, when the UV-curable polymer or oligomer itself has no ultraviolet absorptivity. The ultraviolet absorbent includes several species of materials such as ultraviolet absorbent, photostabilizer, dye and inorganic or organic filler. Suitable examples of the ultraviolet absorbent include, but are not limited to, TINUVIN series available from Ciba Specialty Chemicals. The ultraviolet absorbent is preferably TINUVIN 400 (hydroxyphenyltriazine) available from Ciba Specialty Chemicals. The amount of the ultraviolet absorbent added is preferably controlled so that the coated layer can have an absorbance level of 1 to 4 at a wavelength of about 350 nm which is effective for UV curing. The suitable amount added depends on the coating thickness of the composition and the blending formulation. The amount of the ultraviolet absorbent is usually from 0.1 to 1 wt %, preferably from 0.15 to 1 wt %, based on the weight of the UV-curable pressure-sensitive adhesive composition.

The UV-curable polymer or oligomer may be a polymer or oligomer which itself has ultraviolet absorptivity. In this case, the ultraviolet absorbent need not be added to the pressure-sensitive adhesive composition. The UV-absorptive UV-curable polymer or oligomer is, for example, a UV-curable polymer or oligomer having a maleimide group. In one embodiment, the UV-absorptive UV-curable polymer or oligomer is a UV-curable polymer or oligomer having a maleimide group, and this polymer or oligomer is obtained, for example, by reacting a reaction mixture containing a polyol, a polyisocyanate and a compound having a hydroxyl group and a maleimide group. As for the polyol and polyisocyanate, the same polyols and polyisocyanates as described above for the UV-curable polyurethane acrylate polymer or oligomer (without a maleimide group) can be used.

In view of coatability of the pressure-sensitive adhesive composition, the molecular weight of the polyol is preferably on the order of 2,000 to 10,000. Examples of the compound containing a hydroxyl group and a maleimide group include 2-hydroxyethyl Citra imide. The content of the compound containing a hydroxyl group and a maleimide group in the oligomer raw material affects the crosslinking and thus, the physical properties after UV curing. The compound containing a hydroxyl group and a maleimide group is preferably present in a proportion of 1 to 5 mol %, more preferably from 3 to 4 mol %, in the oligomer raw material. With such an amount, a nontacky substance, or a substance reduced in tack, is obtained after thorough UV curing and this can be effectively used in the present invention. Examples of the polyisocyanate include general organic diisocyanates such as isophorone diisocyanate.

The UV-curable polymer or oligomer having a maleimide group may be a functional UV-curable polyurethane polymer or oligomer imparted with several functions by selecting a certain kind of the polyol. Such a UV-curable polyurethane oligomer is supplied by Toagosei Co., Ltd. For example, ARONTAC UVA-2200 series is a UV-curable polyurethane oligomer using a polypropylene glycol as the polyol. The cured material has light tack and high moisture vapor transmission rate (MVTR). ARONTAC UVA-2200-2 is a material suitable for medical uses, ARONTAC UVA-2200-E3 is a UV-curable polyurethane oligomer using, as the polyol, a polyalkylene glycol based on a block copolymer comprising 10% of ethylene oxide and 90% of propylene oxide, and ARONTAC P-2 is a UV-curable polyurethane oligomer using, as the polyol, a polyalkylene glycol based on a block copolymer comprising 40% of ethylene oxide and 60% of propylene oxide. The cured material using ARONTAC UVA-2200-E3 has lower tack and higher MVTR than that using UVA-2200-2. The cured material using ARONTAC P-2 has a still higher MVTR, but the water itself is absorbed to the cured material and therefore, the cured material using ARONTAC P-2 may not be waterproof. ARONTAC UVA-2100 series are a UV-curable polyurethane oligomer using a polyester polyol as the polyol. The cured material using UVA-2100 series has high adhesive force and low MVTR. UVA-2103 is a material suitable for medical uses.

The UV-curable oligomer of this type is crosslinked by the bonding of two maleimide groups upon UV irradiation and therefore, does not require addition of UV photoinitiator and blocking of oxygen. The maleimide group has a UV absorbing effect and in turn, the UV-curable polyurethane oligomer having a maleimide group is UV-absorptive by itself. Therefore, for the mixture containing a UV-curable polyurethane oligomer having a maleimide group, the addition of an ultraviolet absorbent is not necessarily required. However, in order to control the degree of cure in the vertical direction from the top surface to the bottom surface at the UV curing, the absorbance must be adjusted. In this respect, a slight amount of an ultraviolet absorbent may be added.

The UV-curable polymer or oligomer may be a mixture of a plurality of UV-curable polymers or oligomers. For example, the UV-curable polyurethane oligomer with bonded maleimide groups may be an oligomer obtained by blending UV-curable polyurethane oligomers differing in the polyol raw material. In particular, when a maleimide group-containing polyurethane oligomer obtained by using a polypropylene glycol as the polyol raw material and a maleimide group-containing polyurethane oligomer obtained by using a polyester polyol as the polyol raw material are blended, the adhesive force can be advantageously increased. Also, when a maleimide group-containing polyurethane oligomer obtained by using, as the polyol raw material, a polyalkylene glycol based on a random or block-copolymer comprising from 10 to 40% of ethylene oxide and from 60 to 90% of propylene oxide, and a maleimide group-containing polyurethane oligomer obtained by using a polyester polyol as the polyol raw material are blended, both the adhesive force and the moisture vapor transmission rate (MVTR) can be advantageously elevated.

The UV-curable polymer or oligomer having UV absorptivity may also be a polymer or oligomer obtained by blending a maleimide group-containing UV-curable polyurethane oligomer using a polypropylene glycol as the polyol (for example, ARONTAC UVA-2200-2) and a maleimide group-containing UV-curable polyurethane oligomer using a polyester polyol (for example, ARONTAC UVA-2103). The maleimide group-containing UV-curable polyurethane oligomer may be an oligomer obtained by blending a UV-curable polyurethane oligomer using, as the polyol, a polyalkylene glycol based on a block copolymer comprising from 10 to 40 mol % of ethylene oxide and from 60 to 90 mol % of propylene oxide (for example, ARONTAC UVA-2200-E3 or ARONTAC P-2) and a maleimide group-containing UV-curable polyurethane oligomer using a polyester polyol (for example, ARONTAC UVA-2103). Furthermore, the UV-curable oligomer mixture may be a mixture obtained by blending a UV-curable polyurethane acrylate oligomer added thereto a UV photoinitiator, and a UV-curable polyurethane oligomer to which maleimide groups are bonded. In the case where a fully cured UV-curable polyurethane acrylate oligomer works out to the pressure-sensitive adhesive, this oligomer may be blended with a certain amount of a UV-curable polyurethane oligomer to which maleimide groups are bonded, so that the UV-curable polyurethane oligomer to which maleimide groups are bonded can cover a certain region of the top surface layer and form a nontacky site on the top surface layer.

As described above, the adhesive force, MVTR and other properties can be controlled by blending several different oligomers. The UV-curable polymer or oligomer may further contain additives such as UV photoinitiators, antioxidants, ultraviolet absorbents, tackifiers, plasticizers, fillers, dyes and medicaments. Also, other polymers having no UV curability may be added as long as the object of the present invention is observed. However, in the case of a pressure-sensitive adhesive composition intended to be applied to skin, addition of a reactive monomer such as certain acrylates may not be preferred.

As described above, in order to obtain the pressure-sensitive adhesive tape of the present invention where the pressure-sensitive adhesive property is substantially suppressed on one surface and maintained on the opposite surface, the pressure-sensitive adhesive composition must have a suitable absorbance for the specific ultraviolet wavelength used in UV curing and the coating thickness of the pressure-sensitive adhesive composition. The absorbance of the pressure-sensitive adhesive composition is preferably adjusted from 1 to 4.

The “absorbance” is A=−log(T/100)=log(Y/X) (wherein A is absorbance, T is transmittance (%)=(X/Y)×100, X is incident light intensity, and Y is a transmitted light intensity) and is measured by A=log(Io/I) (wherein Io is transmitted light intensity of blank cell, and I is transmitted light intensity of sample cell).

The pressure-sensitive adhesive tape of the present invention can be produced, for example, as follows. A pressure-sensitive adhesive composition containing a UV-curable polymer or oligomer is coated on a base liner to an appropriate thickness. The pressure-sensitive adhesive composition is suitably coated on a polyester liner by a hot-melt coater at a temperature of 40° C. to 100° C., called warm melt, so that a viscosity of 100,000 mPaS or less can be obtained. The viscosity is preferably 10,000 mPaS or less. The coating temperature is adjusted to give a viscosity suitable for each mixture. The coating thickness is usually from 0.02 to 1 mm. If the thickness exceeds 1 mm, the absorbance is difficult to control from 1 to 4 in many cases, and because UV light cannot reach the bottom surface layer, the composition may not be adequately cured. In the case of a composition using only a maleimide group-containing UV-curable polyurethane oligomer, the coating layer can be cured by directly irradiating UV from a high-pressure mercury lamp. However, in the case of a composition using a UV-curable polyurethane acrylate oligomer having added thereto a UV photoinitiator, a top cover liner must be laminated on the coating layer so as to block oxygen. For the composition using only a UV-curable polyurethane acrylate oligomer having added thereto a UV photoinitiator, the top cover liner may be a polyester or polypropylene liner where a silicone release agent is coated on the side coming into contact with the pressure-sensitive adhesive layer.

For the composition using a maleimide group-containing UV-curable polyurethane oligomer, ultraviolet light at a wavelength of 300 nm is effectively used in view of absorptivity of the maleimide group. As for the top cover liner, a polypropylene liner allowing for transmission of ultraviolet light at 300 nm (to be absorbed by the maleimide group) can be used. In the case where slight release is required, a silicone release agent is coated on the side coming into contact with the pressure-sensitive adhesive layer.

The pressure-sensitive adhesive tape can be obtained by curing the pressure-sensitive adhesive composition, but a non woven fabric or a scrim such as plastic net may be inserted as a reinforcement into the inside of the pressure-sensitive adhesive layer. The scrim can be inserted by disposing a non-woven fabric or scrim on a base liner, coating a pressure-sensitive adhesive composition thereon, covering a top cover liner, if desired, and then performing UV curing. Examples of the scrim include, but are not limited to, a non woven fabric made of polyester, polypropylene, nylon or polyurethane, and a plastic net made of polyethylene or polypropylene. When using a scrim having low or no extensibility, the stretching property of the pressure-sensitive adhesive layer may become compromised. Examples of a scrim having no extensibility include, but are not limited to, MELFIT, a polyester-made non woven fabric, available Unisel, Ltd. in Japan. Examples of the net scrim having no extensibility include, but are not limited to, DELNET, a polyethylene-made net, available from Sansho Co., Ltd. in Japan. For obtaining elongation and reinforcement, a polyurethane-made non woven fabric is preferred. Examples of the non woven fabric having extensibility include, but are not limited to, ESPANSIONE, polyurethane-made non woven fabric, available from Kanebo Co., Ltd. in Japan.

The coating layer is cured by UV irradiation. The wavelength for curing is not limited but may be from 300 to 350 nm for a polyurethane acrylate oligomer composition, and preferably 300 nm for a maleimide group-containing polyurethane oligomer composition. The total irradiation energy depends on the absorbance of the oligomer composition. The appropriate dose is from 200 to 1,500 mJ/cm² for the coating layer having an absorbance of 1 to 4. The appropriate energy is determined by measurements such as adhesive force and adhesive residue to the polypropylene sheet. The single-layer pressure-sensitive adhesive cured under proper conditions has good adhesive force and leaves no adhesive residue. The UV light source is preferably a high-pressure mercury lamp. A UV light source using an H bulb manufactured by Fusion can also be used for curing. The curing temperature is controlled by a cooling plate from 20° C. to 40° C. for keeping constant the cured state.

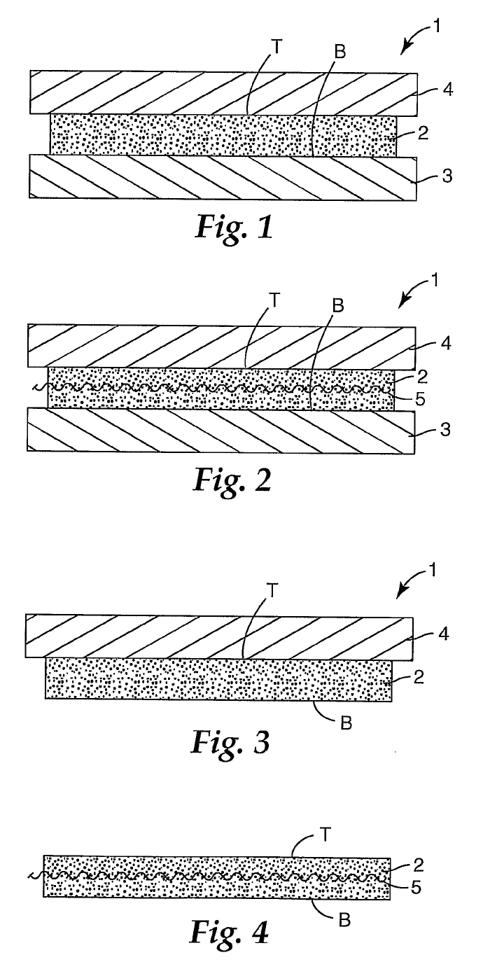

The final product using the pressure-sensitive adhesive tape or film of the present invention has several structures. The difference in the structure is ascribable to the kind of liner, kind of scrim, release tab and supply mode (sheet or roll). FIGS. 1 and 2 each is a cross-sectional view of a precut product of the pressure-sensitive adhesive tape or film of the present invention. The pressure-sensitive adhesive layer 2 of the pressure-sensitive adhesive tape or film 1 is interposed between the base liner 3 contacting with the bottom surface B where pressure-sensitive adhesive property (tack) is maintained, and the top liner (carrier liner) 4 working as a carrier film and contacting with the top surface T where the pressure-sensitive adhesive property is suppressed. First, the base liner 3 is separated and the pressure-sensitive adhesive layer 2 is bonded to an adherend (for example, human skin). After the bonding, the top liner 4 is separated from the nontacky top surface.

The pressure-sensitive adhesive tape or film 1 shown in FIG. 1 does not contain a scrim, and the pressure-sensitive adhesive tape shown in FIG. 2 contains a scrim 5. In each case, a tab site having no pressure-sensitive adhesive property is preferably provided at least at one end so that the operation of separating liner or removing the pressure-sensitive adhesive tape from the adherend can be facilitated. The tab site can be formed by leaving a scrim portion not coated with the pressure-sensitive adhesive. Such a tab site functions as a release tab facilitating the separation from the adherend. On the other hand, with or without a scrim, a nontacky tab site can be formed by UV-curing both surfaces of the pressure-sensitive adhesive composition at an end part.

FIGS. 3 and 4 each is a cross-sectional view of a pressure-sensitive adhesive tape or film when a roll-type product is unrolled. FIG. 3 shows the structure of a roll product with a carrier liner. After bonding, the carrier liner 4 is removed. FIG. 4 shows the structure of a roll product with a scrim not using a carrier liner. The bottom surface B having good adhesive force does not self-weld to the nontacky top surface T and therefore, the roll product can be formed into a roll without coating a low-adhesion backsize (LAB). For this structure, when a scrim 5 is inserted as a reinforcement, a sufficiently high strength can be obtained at unrolling. Other modes of the product include structures where in the tape shown in FIG. 1 or 2, the top liner 4 is not provided. In these structures, the nontacky top surface T is exposed to the outside of the product. In this product mode, certain graphics can be printed on the top surface T by a printing machine such as inkjet printer and/or a color can be coated with an ink by using a coating apparatus such as gravure coating. This kind of product having a graphics or coloring can be utilized for industrial decorative film.

The pressure-sensitive adhesive tape or film of the present invention is a pressure-sensitive adhesive tape or film requiring no supporting substrate by having a nontacky surface on one side and a surface on the opposite side with sufficiently high tack and adhesive force. The pressure-sensitive adhesive tape or film of the present invention can be widely applied not only to a health care field involving contact with human skin but also to other industrial fields. The tape or film of the present invention has a fundamental structure comprising a single layer and therefore, the structure thereof is quite simple, so that simplification of the production process can be realized. The single-layer pressure-sensitive adhesive tape itself is easily elongated, so that the pressure-sensitive adhesive tape can be fixed to a curved surface, a complicated structure or a movable part. Also, separation by the stretch release effect is attainable. The nontacky surface of the pressure-sensitive adhesive tape of the present invention is fully cured and the opposite surface has sufficiently high cohesive force and good adhesive force. Self-welding does not occur between the surfaces, so that a roll tape can be formed without coating a release agent (LAB) on the nontacky surface.

In healthcare applications, the pressure-sensitive adhesive tape or film of the present invention has many advantageous features as compared with conventional thin surgical tape or dressing film using a supporting substrate. The pressure-sensitive adhesive tape or film is easily elongated and therefore, can be fixed to a curved surface, a complicated structure or a movable part. The pressure-sensitive adhesive tape or film of the present invention can be gaplessly fitted to almost all portions of a human body and therefore, can be applied to a surgical tape, a surgical dressing film or a skin-protecting film against wounds, such as bedsores or shoe sores. The pressure-sensitive adhesive tape or film of the present invention uses no supporting substrate and therefore, causes less skin irritation by the edge of the substrate film. This single-layer pressure-sensitive adhesive tape product can be produced to have a resistance property and a high moisture vapor transmission rate (MVTR) of 500 gm/m²*24 hours or more and therefore, is free from moisture retention and mild to human skin. Furthermore, the pressure-sensitive adhesive tape or film of the present invention may contain medical preparations such as antifungals, skin lotion, perfume, salicylic acid and indomethacin.

The pressure-sensitive adhesive tape or film of the present invention can be widely utilized for other industrial uses. The pressure-sensitive adhesive tape or film can be printed with graphics or coated with color and therefore, can be used as a decorative film for a curved surface or a complicated shape.

The present invention is described in greater detail below by referring to Examples, but the present invention is not limited to these Examples. The blending ratios all are on the mass basis.

### EXAMPLES

### Example 1

### Production of Single-Layer Pressure-Sensitive Adhesive Tape

A UV-curable polyurethane acrylate oligomer EBERCY 2001 (EB2001) of Daicel UCB, or LIGHT-TACK PUA 901 or Kyoeisha Chemical Co., Ltd.) as the UV-curable oligomer, IRGACURE-2959 of Ciba Specialty Chemicals as the UV initiator, and IRGANOX-245 of Ciba Specialty Chemicals as the antioxidant were blended at a blending ratio shown in Table 1 below to obtain HEB2001 and PUA2300.

TABLE 1

| | HEB2001 | PUA2300 |
|---|---|---|
| EB2001 | 99.85 | |
| PUA-901 | | 99.85 |
| IRGANOX-245 | 0.1 | 0.1 |
| IRGACURE-2959 | 0.05 | 0.05 |
| Total | 100 | 100 |

HEB2001 and PUA2300 each was blended with TINUVIN 400 of Ciba Specialty Chemicals as the ultraviolet absorbent at a blending ratio shown in Tables 2 and 3 below.

TABLE 2

| | HEB2001 | HEB2001T0.1 | HEB2001T0.15 | HEB2001T0.4 | HEB2001T0.6 |
|---|---|---|---|---|---|
| HEB2001 | 100 | 99.9 | 99.85 | 99.6 | 99.4 |
| TINUVIN 400 | 0 | 0.1 | 0.2 | 0.4 | 0.6 |
| Total | 100 | 100 | 100 | 100 | 100 |

TABLE 3

| | PUA2300 | PUA2300T0.15 | PUA2300T0.17 | PUA2300T0.2 |
|---|---|---|---|---|
| PUA2300 | 100 | 99.85 | 99.83 | 99.8 |
| TINUVIN | 0 | 0.15 | 0.17 | 0.2 |
| 400 | | | | |
| Total | 100 | 100 | 100 | 100 |

The blended products obtained above each was coated by a hand coater to give a gap of 0.1 mm between two sheets of OPP-40, 40 μm-thick polypropylene liner, produced by Tohcello Co., Ltd. The absorbance of the blended products was measured as follows. The absorbance was determined from the transmitted light intensity (I) at 350 nm of the sample sheet interposed between two liners and the transmitted light intensity (Io) at 350 nm of the blank sample comprising only two liners. The absorbance is A=log(Io/I). Separately, the blended product was coated by a hot-melt coater at 80° C. to give a gap of 0.1 mm between OPP-40, 40-μm polypropylene liner, produced by Tohcello Co., Ltd. and A-50, 50-μm polyester liner, produced by Teijin DuPont Films Japan Limited, and then cured by irradiating UV from the polyester liner side with an H bulb-mounted Fusion UV lamp (120 W/cm). The UV energy for curing was adjusted to give a cured state to the extent of not causing adhesive residue on the polypropylene liner when the single-layer pressure-sensitive adhesive obtained by curing was separated from the polypropylene liner. The cured single-layer pressure-sensitive adhesive was evaluated for the thickness, finger tack on both surfaces, and adhesive force of both surfaces to polypropylene sheet.

The adhesive force was judged by bonding the pressure-sensitive adhesive tape to a polypropylene sheet and performing a 180° peel test at a rate of 300 mm/min. The adhesive force of 10 g/inch or less is defined as weak adhesive force, and the adhesive force of 50 g/inch or more is defined as good adhesive force.

The skin adhesive force was judged by bonding the pressure-sensitive adhesive tape to a human front arm and performing a 180° peel test. The adhesive force of 50 g/inch or less is weak skin adhesive force, and the adhesive force of 50 g/inch or more is defined as good skin adhesive force. The optimal skin adhesive force is a level of 70 to 200 g/inch.

“No tack” means that the surface was judged to be nontacky by finger contact with an adhesive force to polypropylene sheet of 10 g/inch or less and the adhesive force to human skin of 50 g/inch or less. “Good tack” means that the surface was judged to have no adhesive residue and exhibit good tack with an adhesive force to polypropylene sheet of 50 g/inch or more and the adhesive force to human skin of 50 g/inch or more. The results are shown in Tables 4 and 5.

TABLE 4

| | HEB2001 | HEB2001T0.1 | HEB2001T0.15 | HEB2001T0.4 | HEB2001T0.6 |
|---|---|---|---|---|---|
| Absorbance | 0.27 | 0.83 | 1.77 | 3.7 | 3.8 |
| Curing | 100 mJ/cm² | 100 mJ/cm² | 100 mJ/cm² | 100 mJ/cm² | 130 mJ/cm² |
| energy | | | | | |
| Thickness | 0.072 mm | 0.072 mm | 0.075 mm | 0.075 mm | 0.068 mm |
| Tack of | no tack | no tack | no tack | no tack | no tack |
| surface 1 | | | | | |
| Tack of | no tack | no tack | slight tack | slight tack | slight tack |
| surface 2 | | | | | |
| Adhesive | 1 g/inch> | 1 g/inch> | 1 g/inch | 1 g/inch> | 1 g/inch> |
| force of | | | | | |
| surface 1 | | | | | |
| Adhesive | 1 g/inch> | 1 g/inch> | 50 g/inch | 95 g/inch | 78 g/inch |
| force of | | | | | |
| surface 1 | | | | | |

TABLE 5

| | PUA2300 | PUA2300T0.15 | PUA2300T0.17 | PUA2300T0.2 |
|---|---|---|---|---|
| Absorbance | 0.08 | 1.8 | 2.3 | 2.8 |
| Curing energy | 465 mJ/cm² | 233 mJ/cm² | 233 mJ/cm² | 155 mJ/cm² |
| Thickness | 0.12 mm | 0.12 mm | 0.12 mm | 0.12 mm |
| Tack of surface 1 | no tack | no tack | no tack | no tack |
| Tack of surface 2 | no tack | Slight tack | slight tack | slight tack |
| Adhesive force of surface | 5 g/inch | 5 g/inch | 5 g/inch | 5 g/inch |
| 1 | | | | |
| Adhesive force of surface | 7 g/inch | 52 g/inch | 63 g/inch | 50 g/inch |
| 2 | | | | |

When the absorbance of the pressure-sensitive adhesive composition is 1 or less, the ultraviolet transmissibility is high and the layered pressure-sensitive adhesive agent from one side to the other side is cured under almost the same conditions. It is seen that when the pressure-sensitive adhesive composition has a predetermined coating thickness and has an absorbance of 1 to 4 at the wavelength of ultraviolet light used for UV curing, the degree of cure can be controlled in the thickness direction of the pressure-sensitive adhesive layer from one surface to the other surface. In other words, when a pressure-sensitive adhesive composition having such an absorbance is used, a single-layer pressure-sensitive adhesive tape being deprived of the pressure-sensitive adhesive property on one surface and maintaining the pressure-sensitive adhesive property on the opposite surface can be obtained.

### Example 2

UV-curable polyurethane oligomers having a maleimide group were used as the UV-curable oligomer. These UV-curable polyurethane oligomers were ARONTAC UVA-2200-2, UVA-2200-E3 and UVA-2103 (Toagosei Co., Ltd.). ARONTAC UVA-2200-2 is a medical grade UV-curable polyurethane oligomer using a propylene glycol for the polyol. ARONTAC UVA-2200-E3 is a medical grade UV-curable polyurethane oligomer using, as the polyol, a polyalkylene glycol based on a block copolymer comprising 10% of ethylene oxide and 90% of propylene oxide. UVA-2103 is a medical grade UV-curable polyurethane oligomer using a polyester polyol as the polyol. To each of these curable oligomers, IRGANOX-245 of Ciba Specialty Chemicals was added as the antioxidant. In the case of UVA-2200-E3, a tackifier (AVALURE AC210 of BF-Goodrich) comprising an ethyl acrylate/acrylic acid copolymer was further added so as to obtain higher tack and adhesive force. The blending ratio of each pressure-sensitive adhesive composition is shown in Table 6.

TABLE 6

| | 3M-2 | 3M-E2-AC10 | HA100 |
|---|---|---|---|
| UVA-2200-2 | 99.9 | | |
| UVA-2200-E3 | | 89.9 | |
| UVA-2103 | | | 99.9 |
| IRGANOX 245 | 0.1 | 0.1 | 0.1 |
| AVALURE AC210 | | 10.0 | |
| Total | 100 | 100 | 100 |

These compositions were measured for the absorbance at 300 nm in the same manner as in Example 1. Furthermore, these compositions each was coated by a hot-melt coater at 50 to 80° C. to give a gap of 0.1 mm between OPP-40, 40-μm polypropylene liner, produced by Tohcello Co., Ltd. and A-50, 50-μm polyester liner, produced by Teijin DuPont Films Japan Limited, and then cured by an H bulb-mounted Fusion UV lamp (120 W/cm) while controlling the curing temperature to 25° C.

In some samples, MELFIT polyester non-woven fabric scrim B7202W of Unisel, Ltd. or DELNET X550 of Sansho Co., Ltd. was disposed as a non-woven fabric for reinforcement on a base liner and the pressure-sensitive adhesive composition was coated thereon, whereby a reinforcement was inserted into the pressure-sensitive adhesive layer. The UV energy for curing was adjusted to give a cured state to the extent of not causing the adhesive of one surface to remain on the polypropylene liner. The cured single-layer pressure-sensitive adhesive was evaluated for the thickness, finger tack on both surfaces, adhesive force of both surfaces to polypropylene sheet, skin adhesive force to surface 2, and moisture vapor transmission rate (MVTR) at 37° C.-40% RH. Samples without a scrim were measured for the breaking strength (g/inch by 300 mm/min) when stretched and elongation (%) by a tensile tester. The test results are shown in Table 7.

TABLE 7

| | Blend | | | | |
|---|---|---|---|---|---|
| | 3M-2 | 3M-2 | 3M-E2-AC10 | 3M-E2-AC10 | HA-100 |
| Absorbance at 300 nm | 1.5 | | 2.8 | | 3.6 |
| Scrim | None | B7202W | none | X550 | none |
| Curing temperature | 25° C. | 25° C. | 25° C. | 25° C. | 25° C. |
| Energy, mJ/sq.cm | 465 | 510 | 465 | 465 | 465 |
| Tack of surface 1 | no | No | no | no | no |
| Tack of surface 2 | good | Good | good | good | good |
| Thickness | 0.12 mm | 0.12 mm | 0.13 mm | 0.13 mm | 0.11 mm |
| Skin adhesive force | 65 g/ | 55 g/ | 83 g/inch | 87 g/inch | 243 g/ |
| | inch | inch | | | inch |
| PP Adhesive force | 173 g/ | 156 g/ | 138 g/inch | 117 g/inch | 572 g/ |
| (AD) | inch | inch | | | inch |
| PP Adhesive force | 5 g/ | 5 g/ | 5 g/inch> | 5 g/inch> | 10 g/inch |
| (TOP) | inch> | inch> | | | |
| Elongation (%/inch) | 135% | *** | 163% | *** | 490% |
| Breaking strength | 191 | *** | 153 | *** | 163 |
| (g/inch) | | | | | |
| MVTR @37 C-40% RH | 782 | 550 | 799 | 653 | 432 |

In all pressure-sensitive adhesive compositions, the absorbance at 300 nm was from 1 to 4 for the coating thickness of 0.1 mm, the degree of cure in the thickness direction from one surface to the opposite surface could be satisfactorily controlled, and a single-layer pressure-sensitive adhesive tape having no pressure-sensitive adhesive property on one surface and having pressure-sensitive adhesive property on the opposite surface was obtained. In the case of a single-layer pressure-sensitive adhesive tape with a scrim, not only the bonding operation but also the peeling operation of pulling the tab site at the end part of the scrim not coated with the pressure-sensitive adhesive were facilitated.

### Example 3

A blend of several kinds of UV-curable oligomers was used as the UV-curable oligomer. To the UV-curable oligomer blend, a UV initiator (IRGACURE-2959), an antioxidant (IRGANOX-245), an ultraviolet absorbent (TINUVIN 400) were added. The formulation of each pressure-sensitive adhesive composition is shown in Table 8 below.

TABLE 8

| | HA30 | HE30 | UVH-210T0.05 |
|---|---|---|---|
| UVA-2200-2 | 69.93 | | 69.87 |
| UVA-2200-E3 | | 69.93 | |
| UVA-2103 | 29.97 | 29.97 | |
| PSA-901-1 | | | 29.97 |
| IRGANOXI-245 | 0.10 | 0.10 | 0.1 |
| IRGACURE-2959 | | | 0.01 |
| TINUVIN 400 | | | 0.05 |
| Total | 100 | 100 | 100 |

The blend of ARONTAC UVA-2200-2 and ARONTAC UVA-2103 took one day at 90° C. until occurrence of phase separation after thorough mixing of these oligomers. Since this blend does not undergo phase separation in a short time, the pressure-sensitive adhesive composition could be coated by a twin-screw extruder without causing phase separation. ARONTAC UVA-2200-E3 and ARONTAC UVA-2103 could be well mixed without occurrence of phase separation. The blend of ARONTAC UVA-2200-2 and LIGHT-TACK PSA-901-1 could be well mixed without occurrence of phase separation.

These pressure-sensitive adhesive compositions were measured for the absorbance at 300 nm (or 350 nm) in the same manner as in Example 1. Also, these pressure-sensitive adhesive compositions each was coated and evaluated in the same manner as in Example 2. The evaluations results are shown in Table 9. The adhesive force, MVTR and other properties could be controlled by blending several different oligomers.

TABLE 9

| | Blend | | | | |
|---|---|---|---|---|---|
| | HA30 | | HE-30 | UVH210T0.05 | |
| Absorbance at 300 nm | 3.0 | | 2.8 | 2.2(300 nm)/ | |
| | | | | 0.33(350 nm) | |
| Scrim | none | X550 | none | none | B7202W |
| Curing temperature | 25° C. | 25° C. | 25° C. | 25° C. | 25° C. |
| Energy (mJ/sq.cm) | 341 | 400 | 222 | 400 | 465 |
| Tack of surface 1 | no | No | no | no | no |
| Tack of surface 2 | good | Good | good | good | good |
| Thickness | 0.13 mm | 0.13 mm | 0.11 mm | 0.13 mm | 0.13 mm |
| Skin adhesive force | 95 g/ | 138 g/ | 98 g/ | 70 g/inch | 80 g/inch |
| | inch | inch | inch | | |
| PP Adhesive force | 230 g/ | 187 g/ | 97 g/ | 147 g/inch | 80 g/inch |
| (AD) | inch | inch | inch | | |
| PP Adhesive force | 5 g/ | 5 g/ | 5 g/ | 5 g/inch> | 5 g/inch |
| (TOP) | inch> | inch> | inch> | | |
| Elongation (%/inch) | 235% | *** | 306% | 259% | *** |
| Breaking strength | 171 | *** | 161 | 207 | *** |
| (g/inch) | | | | | |
| MVTR @37 C-40% RH | 682 | 474 | 1010 | 808 | 869 |

From the pressure-sensitive adhesive tapes obtained in Examples 1 to 3, final products having several structures were formed. FIGS. 1 and 2 each shows a cross-sectional view of a precut sheet product obtained by cutting a pressure-sensitive adhesive tape UV-cured between two liners in Examples above, into an appropriate size. The base liner was separated from the surface having pressure-sensitive adhesive property, and the pressure-sensitive adhesive layer was bonded to human skin. After bonding, the top liner was separated from the top surface of the pressure-sensitive adhesive layer, as a result, the surface having non-pressure-sensitive adhesive property was exposed and a pressure-sensitive adhesive layer comprising only a single layer remained. FIG. 1 is an example not using a scrim, and FIG. 2 is an example in the case of containing a scrim. In each case, a tab site having no pressure-sensitive adhesive was present at least at one end so as to facilitate the operation for liner separation and removal from adherend. In the case of containing a scrim, the tab site as a separation tab could be formed by not coating the pressure-sensitive adhesive composition on the end part of the scrim. In the case of containing no scrim, the tab site as a separation tab could be formed by UV-curing only the end part of the pressure-sensitive adhesive layer from both surfaces and thereby making the both surfaces to be nontacky.

From the single-layer pressure-sensitive adhesive tapes of Examples 2 and 3, roll-type products shown in FIGS. 3 and 4 were formed. FIG. 3 shows a cross-sectional view of a roll product with a carrier liner when unrolled. After bonding, the carrier liner was removed. FIG. 4 shows a cross-sectional view of a roll product with a scrim not using a carrier liner, when unrolled. Since the bottom surface having adhesive force does not self-weld to the nontacy top surface, the roll product could be formed without coating a low-adhesion backsize (LAB). For this structure, a scrim can be inserted as a reinforcement so as to elevate the strength of pressure-sensitive adhesive tape at unrolling.

Other modes of the product include structures where in the precut products shown in FIGS. 1 and 2 using the single-layer pressure-sensitive adhesive tapes of Examples 2 and 3, the top carrier liner is not provided. In these structures, the nontacky top surface is exposed to the outside. In this product, a graphics could be printed on the top surface by an inkjet printer. This product with graphics could be utilized as a decorative film.

### Example 5

A pressure-sensitive adhesive tape of the present invention was obtained by further adding an additive to the UV-curable oligomer-containing pressure-sensitive adhesive composition of Example 2 and FIG. 3. The formulation in adding a microcapsule enclosing catechin extracted from green tea leaf, to the pressure-sensitive adhesive composition containing a UV-curable oligomer having a maleimide group is shown in Table 10 below. The catechin microcapsule used was CATECHIN HCMt-1 powder of ENEX Co., Ltd. The pressure-sensitive adhesive composition containing the microcapsule enclosing catechin was coated and cured in the same manner as in Example 3. The catechin-containing single-layer pressure-sensitive adhesive was formed as a functional medical tape.

TABLE 10

| | HE30CATECHIN |
|---|---|
| UVA-2200-E3 | 69.43 |
| UVA-2103 | 29.47 |
| IRGANOX-245 | 0.10 |
| CATECHIN MCMt-1 | 1.00 |
| Total | 100.00 |

By the addition of such an additive, the cured pressure-sensitive adhesive tape can be used for various applications. The catechin has several effects such as antibiotic effect and anti-allergic effect. The single-layer pressure-sensitive adhesive tape having added thereto this additive is expected to provide the same effects.

1. A pressure-sensitive adhesive tape or film obtained by curing a UV-curable pressure-sensitive adhesive composition containing a UV-curable polymer or oligomer, wherein the UV curing is controlled to give a higher degree of cure to one surface of said pressure-sensitive adhesive tape or film than that on the opposite surface and thereby the pressure-sensitive adhesive property is suppressed on said one surface and maintained on the opposite surface.

2. The pressure-sensitive adhesive tape or film as claimed in claim 1, wherein said UV-curable pressure-sensitive adhesive composition exhibits an absorbance of 1 to 4 at the UV curing wavelength for the coating thickness on performing the UV curing.

3. The pressure-sensitive adhesive tape or film as claimed in claim 1, wherein said UV-curable pressure-sensitive adhesive composition contains a UV-curable polymer or oligomer and an ultraviolet absorbent.

4. The pressure-sensitive adhesive tape or film as claimed in claim 3, wherein the UV-curable oligomer comprises a UV-curable polyurethane acrylate oligomer and the composition further comprises a UV initiator.

5. The pressure-sensitive adhesive tape or film as claimed in claim 1, wherein the UV-curable polymer or oligomer has ultraviolet absorptivity.

6. The pressure-sensitive adhesive tape or film as claimed in claim 5, wherein said UV-curable polymer or oligomer having ultraviolet absorptivity is a UV-curable polymer or oligomer having a maleimide group.

7. The pressure-sensitive adhesive tape or film as claimed in claim 6, wherein said UV-curable polymer or oligomer having a maleimide group is synthesized by a reaction of a reaction mixture containing a polyol, a polyisocyanate and a monomer having a hydroxyl group and a maleimide group.

8. The pressure-sensitive adhesive tape or film as claimed in claim 7, wherein the polyol is a polypropylene glycol; a polyalkylene glycol based on a random or block copolymer comprising from 10 to 40 mass % of ethylene oxide and from 60 to 90 mass % of propylene oxide; or a polyester polyol.

9. The pressure-sensitive adhesive tape or film as claimed in claim-1, wherein said UV-curable pressure-sensitive adhesive composition further contains an additive selected from the group consisting of an antioxidant, an ultraviolet absorbent, a tackifier, a plasticizer, a filler, a dye and a medicament.

10. The pressure-sensitive adhesive tape or film as claimed in claim 1, wherein said pressure-sensitive adhesive tape or film is a single-layer tape or film comprising only a UV cured product of said UV-curable pressure-sensitive adhesive composition.

11. The pressure-sensitive adhesive tape or film as claimed in claim 10, wherein said single-layer tape or film has a non-woven fabric or a scrim as a reinforcement on one side of the single-layer tape.

12. The pressure-sensitive adhesive tape or film as claimed in claim 11, wherein the pressure-sensitive adhesive composition is not coated on the end portion of said non-woven fabric or scrim to form a non-pressure-sensitive adhesive tab at the end portion of the pressure-sensitive adhesive tape or film.

13. The pressure-sensitive adhesive tape or film as claimed in claim 1, wherein ultraviolet light is irradiated on both surfaces at the end of the pressure-sensitive adhesive tape or film to form a non-pressure-sensitive adhesive tab at the end portion of the pressure-sensitive adhesive tape or film.

14. The pressure-sensitive adhesive tape or film as claimed in claim 1, wherein on the pressure-sensitive adhesive property-suppressed surface of the pressure-sensitive adhesive tape or film, an ink printed layer is further provided.

15. A UV-curable pressure-sensitive adhesive composition comprising a UV-curable polymer or oligomer adjusted to exhibit an absorbance of 1 to 4 at the UV-curing wavelength.

16. A pressure sensitive adhesive tape or film comprising a UV-cured pressure sensitive adhesive composition; wherein the pressure-sensitive adhesive composition comprises a UV-curable polymer or oligomer; wherein the degree of UV-cure in the composition decreases in the thickness direction from one side of the tape or film to the opposite side; and
wherein the side with the increased degree of UV-cure has a suppressed pressure-sensitive adhesive property relative to the opposite side.

17. A method of making a UV-cured pressure-sensitive adhesive tape or film, comprising:
providing a UV-curable polymer or oligomer and optionally a UV absorbent to form a UV-curable composition;
coating the UV-curable composition; and
curing the UV-curable pressure-sensitive adhesive composition in the thickness direction of the coating.

18. The method of claim 17, wherein the increase in cure in the thickness direction suppresses the pressure-sensitive adhesive property of the coating on the side with increased cure.

19. The method of claim 17, wherein the curing occurs at a UV wavelength of 300 nm.

20. The method of claim 17, wherein the absorbance of the pressure-sensitive adhesive composition is from 1 to 4.

21. The method of claim 17, the UV-curable polymer or oligomer comprises a maleimide group.

22. (canceled)

23. The pressure-sensitive tape or adhesive of claim 2, wherein the UV curing is controlled at a wavelength of 300 nm.
